(19) United States
(12) Patent Application Publication
(10) Pub. No.: US 2003/0058368 A1
(43) Pub. Date: Mar. 27, 2003

(54) Image warping using pixel pages

(76) Inventor: Mark Champion, Kenmore, WA (US)

Correspondence Address: Scott J. Menghini, 120 S. La Salle Street, Suite 1600, Chicago, IL, 60603-3406, US

(21) Appl. No.: 10/107,118

(22) Filed: Mar. 26, 2002

Related U.S. Application Data
(60) Provisional application No. 60/324,498, filed on Sep. 24, 2001.

(51) Int. Cl. H04N 9/74; H04N 3/23

(52) U.S. Cl. 348/581; 348/746

(57) ABSTRACT

Methods and apparatus for image warping using pixel pages. In one implementation, a vertical scaling system includes: a pixel page system, where the pixel page system stores pixel data using pixel pages according to horizontal rows of pixels in a frame and retrieves pixel data using pixel pages according to vertical columns of pixels in a frame; and a scaling engine connected to the pixel page system, where the scaling engine scales pixel data according to vertical columns of pixels in a frame.

### RELATED APPLICATIONS

This application is related to the following co-pending and commonly assigned patent applications: U.S. application Ser. No. 10/051,538, filed Jan. 16, 2002 (Docket No. 71743); U.S. application Ser. No. 10/051,680, filed Jan. 16, 2002 (Docket No.71744); U.S. application Ser. No. 10/052,074, filed Jan. 16, 2002 (Docket No. 71745); and U.S. application Ser. No. 10/051,541, filed Jan. 16, 2002 (Docket No. 71746), the disclosures of which are incorporated herein by reference.

This application claims the benefit of U.S. Provisional Application No. 60/324,498 filed Sep. 24, 2001, the disclosure of which is incorporated herein by reference.

### BACKGROUND

Conventional projection systems often encounter geometry distortion problems when projecting an image onto a projection surface. One such geometry distortion problem is referred to as “keystone” distortion. Horizontal keystone distortion is illustrated in FIG. 1. While the frame of pixels 105 to be displayed is rectangular, due to distortions in projection, the projected image 110 appears trapezoidal, similar to a keystone in an arch. Keystone distortion typically results from projecting the image at an oblique angle relative to the projection surface. In the example shown in FIG. 1, the bottom row of pixels appears undistorted while each row of pixels above that row appears progressively more stretched and so the same number of pixels occupy a wider space in the upper rows.

Applying horizontal keystone correction to the pixel data before the image is projected can hide the keystone distortion. In one typical solution, pixel data is supplied to the projection system according to horizontal rows of pixels in the frame 105, and the projection system scales the pixel data for each row of pixels. The projection system projects an image according to horizontal rows of pixels using the scaled pixel data forming a scaled projection 115. Each row of pixel data is scaled to form a visible section 120 of pixels that is of approximately constant width from row to row. Pixels at the edge of the visible section 120 are aliased to enhance the appearance of a smooth edge for the visible section 120. Due to the keystone distortion, some rows have fewer pixels in the visible section 120 than others. The remaining pixels form blacked-out sections 125 on either side of the visible portion 120. Pixels in the blacked-out section 125 either have black data (e.g., projected as black) or the pixels are not lit at all.

### SUMMARY

The present disclosure provides methods and apparatus for image warping using pixel pages. In one implementation, a vertical scaling system includes: a pixel page system, where the pixel page system stores pixel data using pixel pages according to horizontal rows of pixels in a frame and retrieves pixel data using pixel pages according to vertical columns of pixels in a frame; and a scaling engine connected to the pixel page system, where the scaling engine scales pixel data according to vertical columns of pixels in a frame.

In another implementation, a method of scaling pixel data includes: receiving pixel data for a frame of pixels according to horizontal rows of pixels in the frame; storing the pixel data according to horizontal rows of pixels in the frame using pixel pages; retrieving the pixel data according to vertical columns of pixels in the frame using pixel pages; and scaling the pixel data according to vertical columns of pixels in the frame.

### BRIEF DESCRIPTION OF THE DRAWINGS

FIG. 1 illustrates an example of horizontal keystone distortion.

FIG. 2 illustrates an example of vertical keystone image distortion.

FIG. 3 is a block diagram of a vertical scaling system.

FIG. 4 is a flowchart of the operation of the vertical scaling system shown in FIG. 3.

FIG. 5 is a representation of one implementation of a pixel page.

FIG. 6 is a block diagram of a pixel page system architecture.

FIG. 7 is a flowchart of storing and retrieving pixel data in parallel using memory alternation.

FIG. 8 is a table showing the relationships among a pixel, a frame row, a frame column, a pixel page, a pixel page row, a pixel page column, a memory page, a memory address, and a memory bank.

FIG. 9 is a flowchart of storing pixel data.

FIG. 10 illustrates generating an address from counter variables.

FIG. 11 is a flowchart of generating source addresses for storing pixel data.

FIG. 12 is a flowchart of retrieving pixel data.

FIG. 13 is a flowchart of generating destination addresses for retrieving pixel data.

FIG. 14 shows another implementation of a vertical scaling system.

FIG. 15 is a flowchart of the operation of the vertical scaling system shown in FIG. 14.

FIG. 16 illustrates an example of vertical bowtie image distortion.

### DETAILED DESCRIPTION

The present invention provides methods and apparatus for image warping using pixel pages. Image warping using pixel pages is useful for correcting vertical image distortion. In overview of one implementation, pixel data received according to horizontal rows of pixels in a frame is translated using a pixel page system to be retrieved according to vertical columns of pixels in the frame. The pixel data is provided according to vertical columns to a scaling engine or filter to correct the vertical distortion. Pixel pages and pixel page systems are described in related patent applications: U.S. application Ser. No. 10/051,538, filed Jan. 16, 2002 (Docket No. 71743); U.S. application Ser. No. 10/051,680, filed Jan. 16, 2002 (Docket No. 71744); U.S. application Ser. No. 10/052,074, filed Jan. 16, 2002 (Docket No. 71745); and U.S. application Ser. No. 10/051,541, filed Jan. 16, 2002 (Docket No. 71746, the disclosures of which are incorporated herein by reference, as noted above.

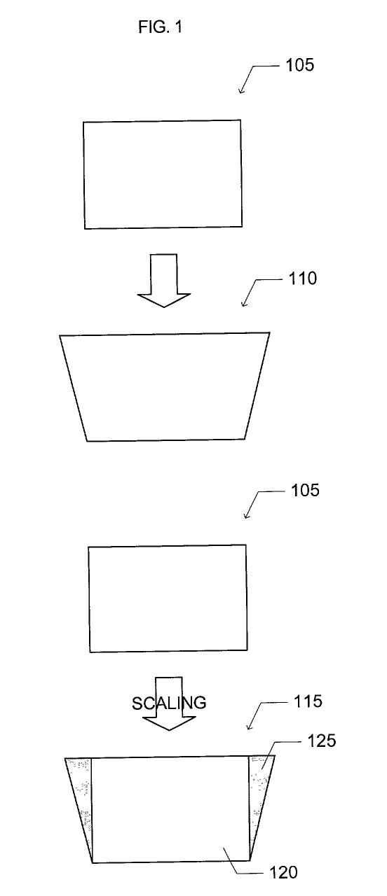

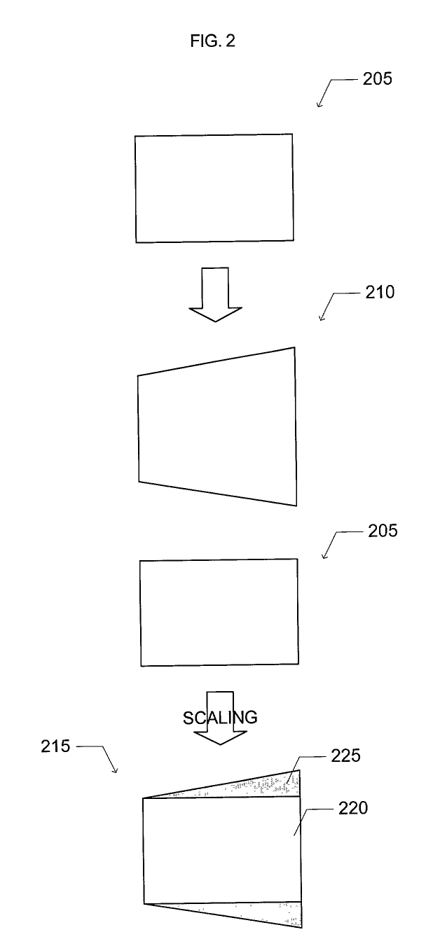

FIG. 2 illustrates an example of vertical keystone image distortion. Similar to the horizontal distortion shown in FIG. 1, a rectangular frame of pixels 205, due to distortions in projection, has a trapezoidal projected image 210. The projected image 210 appears as a keystone rotated 90 degrees. In the example shown in FIG. 2, the leftmost column of pixels appears undistorted while each column of pixels to the right of that column appears progressively more stretched and so the same number of pixels occupy a taller space in the right columns.

Similar to correcting horizontal keystone distortion, applying vertical keystone correction to the pixel data before the image is projected can hide the vertical keystone distortion. Vertical keystone correction scales the pixel data for a column of pixels. A scaling engine scales the pixel data for each column and provides the scaled data to a projection system. The projection system projects an image according to vertical columns of pixels using the scaled pixel data forming a scaled projection 215. Each column of pixel data is scaled to form a visible section 220 of pixels that is of approximately constant height from column to column. Pixels at the edge of the visible section 220 are aliased to enhance the appearance of a smooth edge for the visible section 220. Due to the keystone distortion, some columns have fewer pixels in the visible section 220 than others. The remaining pixels form blacked-out sections 225 on either side of the visible portion 220. Pixels in the blacked-out section 225 either have black data (e.g., projected as black) or the pixels are not lit at all.

To scale the pixel data for a column of pixels, pixel data for each pixel in the column of pixels is needed. Alternatively, pixel data for pixels can be progressively scaled, but still pixel data for multiple pixels in the column are desirable. Where the pixel data is supplied to a scaling engine according to horizontal rows of pixels, pixel data for entire rows or the entire frame of pixels would be buffered to scale only the first column. However, by providing the pixel data to a pixel page system before the data is provided to the scaling engine, the pixel page system can provide the pixel data to the scaling engine according to vertical columns of pixels.

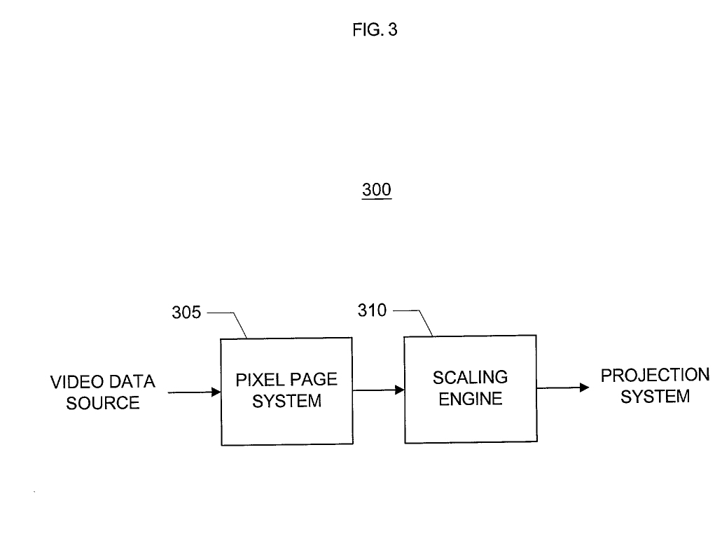

FIG. 3 is a block diagram of a vertical scaling system 300. The vertical scaling system 300 receives pixel data from an external video data source, such as a broadcast source or a software application running on a computer system, and provides scaled pixel data to an external projection system. The vertical scaling system 300 includes a pixel page system 305 and a scaling engine 310, connected in series. The pixel page system 305 uses pixel pages to store pixel data according to horizontal rows of pixels and retrieve the pixel data according to vertical columns of pixels.

The scaling engine 310 scales pixel data according to vertical columns of pixels, such as to correct vertical keystone distortion. The scaling engine 310 uses one or more scaling factors to scale the pixel data. For example, the scaling engine 310 reduces the size of the rightmost column of pixels by 10% and does not scale the leftmost column of pixels. The intervening columns are progressively scaled between 0 and 10%. In another implementation, the scaling engine 305 is a filter using filter coefficients to adjust the pixel data to correct the image distortion. In one implementation, the scaling engine 310 outputs pixel data for both the visible section and the blacked-out sections of the scaled projection. In another implementation, the scaling engine 310 only outputs pixel data for pixels in the visible section (e.g., when the memory locations are initialized to black and so creating the blacked-out sections using the default black data).

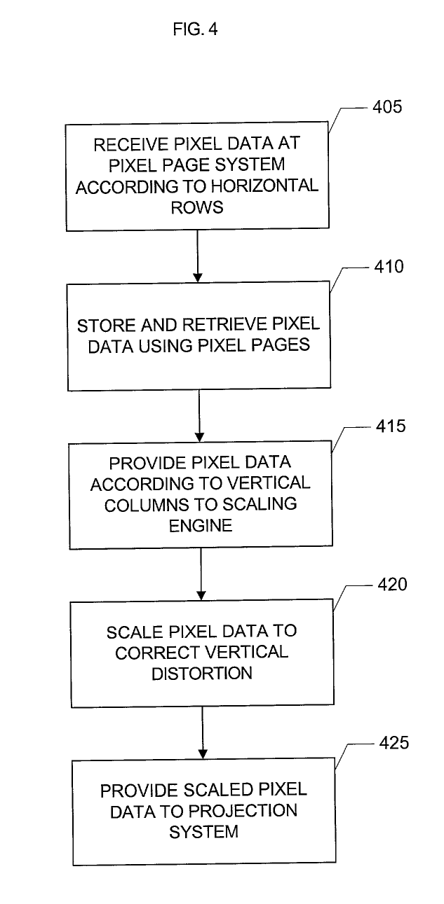

FIG. 4 is a flowchart of the operation of the vertical scaling system 300 shown in FIG. 3. The pixel page system 305 receives pixel data according to horizontal rows of pixels in a frame from an external video data source, block 405. The pixel page system 305 uses pixel pages to store pixel data according to horizontal rows of pixels and retrieve the pixel data according to vertical columns of pixels, block 410. The pixel page system 305 provides the pixel data according to vertical columns of pixels to the scaling engine 310, block 415. The scaling engine 310 scales the pixel data for each column, block 420. The scaling engine 310 provides the scaled pixel data, according to vertical column of pixels, to an external projection system, block 425.

Pixel pages and pixel page systems are described in depth in the patent applications referenced above (e.g., U.S. application Ser. No. 10/051,538, filed Jan. 16, 2002 (Docket No. 71743)). A description of pixel pages and an illustrative implementation of a pixel page system for a vertical scaling system is described below.

For a pixel page system in a vertical scaling system, pixel pages are used for storing pixel data in a first order and retrieving pixel data in a second order. In one pixel page system, pixel data is supplied to the pixel page system according to the horizontal order of pixels in a frame, such as from left to right, top to bottom. Pixel data is provided by the pixel page system according to the vertical order of pixels in a frame, such as from top to bottom, left to right. Pixel pages are configured to support storing and retrieving pixel data in these two different orders. In another pixel page system, pixel data is supplied to the pixel page system according to vertical columns of pixels and provided by the pixel page system according to horizontal rows of pixels.

Each pixel page is a two-dimensional mapping of pixels and pixel data to memory locations, aligning rows and columns within the pixel page with rows and columns in the frame of pixels. One dimension of the pixel page, referred to as pixel page rows, corresponds to horizontal rows of pixels in the frame, referred to as frame rows. A second dimension of the pixel page, referred to as pixel page columns, corresponds to vertical columns of pixels in the frame, referred to as frame columns. A pixel page has multiple pixel page rows and multiple pixel page columns. Each pixel page indicates memory locations from a single physical memory page so that consecutive accesses to locations from a single pixel page do not cause page misses. Accordingly, accessing consecutive locations corresponding to a pixel page along a pixel page row or along a pixel page column does not cause page misses. Page misses can occur at the end of a pixel page row or pixel page column in making a transition to another pixel page. By storing pixel data along pixel page rows and retrieving data along pixel page columns, page misses can be reduced in processing pixel data that is to be stored in one order and retrieved in another order.

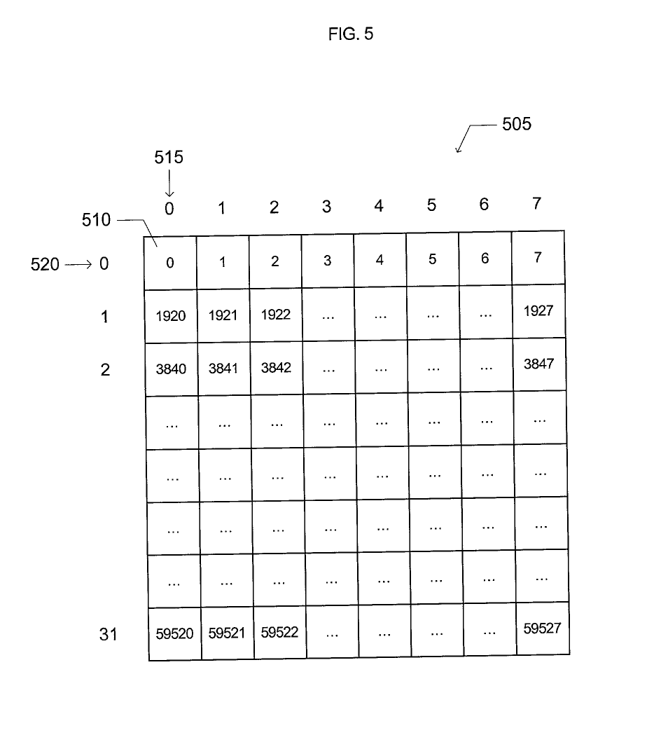

FIG. 5 is a representation of one implementation of a pixel page 505 of pixels 510 in a high definition (HD) resolution implementation. One HD resolution is 1920×1080. A pixel page 505 has a pixel page geometry of 8×32. Alternative implementations can use different pixel page geometries. Pixels 510 in the pixel page 505 shown in FIG. 5 are numbered as the pixels 510 would be numbered in the corresponding 1920×1080 frame for the first pixel page 505 (i.e., the pixel page in the top left corner of the frame). A pixel page 505 includes 256 pixels 510, in 8 pixel page columns 515 (numbered 0 to 7) and 32 pixel page rows 520 (numbered 0 to 31). A pixel page column 515 includes 32 pixels 510 and a pixel page row 520 includes 8 pixels 510. For clarity, not every pixel 510 of the pixel page 505 is shown in FIG. 5. Ellipses indicate intervening pixels 510.

Pixel data for each pixel page 505 is stored in a respective page of physical memory. Where a memory page has 256 4-byte locations, pixel data for each of the 256 pixels in an 8×32 pixel page 505 is stored in a respective location. As shown in FIG. 5, memory locations progress left to right, top to bottom. Accordingly, pixel data for pixel 0 is stored in memory location 0 and pixel data for pixel 1 is stored in memory location 1. Similarly pixel data for pixel 1920 is stored in memory location 8. A similar pattern applies throughout the pixel page 505 and throughout the other pixel pages 505 of the frame.

In storing pixel data for a 1920×1080 frame, because the pixel pages 505 are 8 pixels 510 wide, a page miss would occur storing pixel data for every 8 pixels 510. Storing one 1920×1080 frame of pixel data would cause a total of 259,200 page misses (240*1080). In retrieving pixel data for a 1920×1080 frame, because the pixel pages 505 are 32 pixels 510 tall, a page miss would occur retrieving pixel data for every 32 pixels 510. Retrieving one 1920×1080 frame of pixel data would cause a total of 65,280 page misses (34*1920). In total, storing and retrieving one 1920×1080 frame of pixels using 8×32 pixel pages 505 would cause 324,480 page misses.

In one implementation, burst accessing or a burst mode is used to access a sequence of memory locations in a memory page. Burst accessing is a well known technique and is described more fully in U.S. application Ser. No. 10/051,538, filed Jan. 16, 2002 (Docket No. 71743). Burst accessing can be used to hide page misses by activating a memory page in a second memory bank while a burst access is being made to a memory page in a first memory bank. Similarly, activating a memory page in the first bank while a burst access is being made to a memory page in the second bank can hide page misses. A cycle of banks can be used for a memory device including more than two memory banks (e.g., activate a page in a third bank while burst accessing in the second bank, and so on looping back to the first bank). Pixel pages correspond to memory pages following this pattern. For example, in one implementation using a memory device having four memory banks, the first pixel page in a frame corresponds to the first memory page in a first bank, the second pixel page corresponds to the first memory page in a second bank, the third pixel page corresponds to the first memory page in a third bank, the fourth pixel page corresponds to the first memory page in a fourth bank, the fifth pixel page corresponds to the second memory page in the first bank, and so on. This pattern continues throughout the frame so that the next memory page to be accessed is in a different bank from the currently accessed memory page.

In another implementation, pixel data for adjacent pixel pages, vertically and horizontally, is stored in different banks. For example, the horizontally and vertically first pixel page (the pixel page including pixel 0) corresponds to the first bank. The horizontally second pixel page (the pixel page including pixel 8 where the pixel page geometry is 8×32) corresponds to the second bank. The vertically second pixel page (the pixel page including pixel 61440 where the pixel page geometry is 8×32) corresponds to the second bank. This pattern continues throughout the frame so that the next memory page to be accessed, while storing or retrieving pixel data, is in a different bank from the currently accessed memory page.

By using burst accessing with pixel pages, page misses can be hidden while storing pixel data. Referring to FIG. 5, using burst accessing with 8×32 pixel pages 505, in storing pixel data for a 1920×1080 frame, because the pixel pages 505 are 8 pixels 510 wide, the end of a pixel page 505 occurs every 8 pixels 510 horizontally. Using burst accessing and multiple memory banks, the page miss that would occur at the boundary of each pixel page can be hidden while storing pixel data. Accordingly, storing one 1920×1080 frame of pixel data would cause one effective page miss (i.e., a page miss that affects timing and is not hidden) in activating the first memory page. Storing pixel data for a sequence of frames would cause only one effective page miss at the start of the first frame. When using burst accessing the horizontal dimension of the pixel page geometry does not affect the number of effective page misses, so long as the pixel page is wide enough to allow burst accessing to be effective. Typically eight cycles is sufficient and so a pixel page width of eight is desirable.

However, typical burst accessing would not help to hide page misses in retrieving pixel data (according to vertical column order) using pixel pages because the sequences of addresses generated using burst accessing are typically consecutive or tightly grouped. Conversely, the addresses needed for retrieving pixel data using pixel pages are not consecutive and may be spaced widely (e.g., 0, 8, 16, etc.) and so typical burst accessing is not applicable. Instead, increasing the pixel page height can reduce the number of page misses while retrieving pixel data, reducing the time lost to page misses. In retrieving pixel data for a 1920×1080 frame, because the 8×32 pixel pages 505 are 32 pixels 510 tall, a page miss would occur retrieving pixel data for every 32 pixels 510. Retrieving one 1920×1080 frame of pixel data would cause a total of 65,280 page misses (34*1920). In total, storing and retrieving one 1920×1080 frame of pixels using 8×32 pixel pages 505 and burst accessing would cause 65,281 effective page misses.

In an alternative implementation, pixel data is stored and retrieved to take advantage of burst accessing while retrieving pixel data. In this case, a pixel page geometry that maximizes the number of pixels along the horizontal dimension while having enough pixels vertically to effectively use burst accessing is desirable. One such pixel page geometry is 32×8.

An HD implementation (1920×1080 screen resolution) of a pixel page system for a vertical scaling system is described below. This implementation is illustrative of the operation of one system and alternative implementations are possible. The operation of this system is similar to the pixel page systems described in U.S. application Ser. No. 10/051,538, filed Jan. 16, 2002 (Docket No. 71743). Altering the pixel page geometry may affect the generation of addresses for storing and retrieving pixel data.

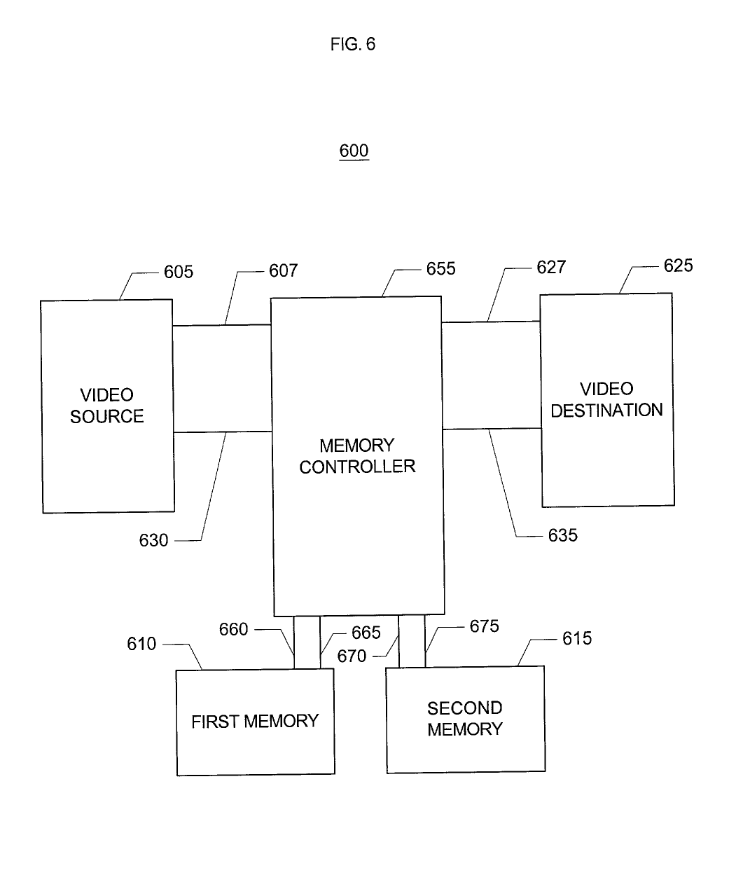

FIG. 6 is a block diagram of a pixel page system architecture 600. The architecture 600 includes a memory controller 655 centrally interconnecting a video source 605, a video destination 625, a first memory 610 and a second memory 615. The video source 605 provides pixel data to the memory controller 655 and a video destination 625 retrieves pixel data from the memory controller 655. Using memory alternation (described below), the memory controller 655 stores and retrieves pixel data to and from memories 610, 615. First memory 610 and second memory 615 are separate memory devices, such as two 32-bit wide 8 MB SDRAM's (e.g., 2M×32 SDRAM MT48LC2M32B2 by Micron Technology, Inc.). The SDRAM is preferably fast enough to support the data rate needed for the screen resolution, such as 150 MHz or 166 MHz. Other types of memory can also be used, such as SGRAM (synchronous graphics RAM).

The video source 605 receives video data from an input of the pixel page system, such as from an input of the vertical scaling system (recall FIG. 3). The video source 605 outputs pixel data for one pixel at a time on a first data bus 607.

The video destination 625 provides pixel data to an output of the pixel page system, such as to be provided to a scaling engine (recall FIG. 3). The video destination 625 receives pixel data for one pixel at a time on a second data bus 627.

In one implementation, the video source 605 and video destination 625 include FIFO buffers, such as to avoid buffer overrun or underrun. In another implementation, these FIFO buffers are included in the memory controller 655. In another implementation, the video source 605 and the video destination 625 and their functionality are included in the memory controller 655.

The first data bus 607 is connected to the video source 605 and the memory controller 655. The second data bus 627 is connected to the video destination 625 and the memory controller 655. The memory controller 655 receives signals from the video source 605 and the video destination 625 through first and second control lines 630 and 635, respectively, for addressing (e.g., indicating whether pixel data is to be stored to or retrieved from the memories 610 and 615), or that horizontal and vertical synchronization signals have been received (e.g., to indicate the end of a frame row of pixels or the end of a frame, respectively). A first memory data bus 660 and a first memory address bus 665 are connected to the memory controller 655 and the first memory 610. A second memory data bus 670 and a second memory address bus 675 are connected to the memory controller 655 and the second memory 615. The first memory 610 and the second memory 615 also receive control signals (not shown) from the memory controller 655 to control whether the memories 610 and 615 will read in data (write mode) or read out data (read mode). In addition, while clock lines are not shown in FIG. 6, the architecture 600 operates based on clock cycles so that pixel data can be processed for two pixels per clock cycle in support of the desired pixel rate (as described below, pixel data for one pixel is stored to one memory while pixel data for another pixel is retrieved from the other memory).

The memory controller 655 controls routing pixel data from video source 605 to the memories 610 and 615 and routing pixel data from the memories 610 and 615 to the video destination 625. The memory controller 655 controls the operation of the memories 610 and 615, such as the read or write state, and also generates addresses for storing pixel data to and retrieving data from the memories 610 and 615, as described below. In an alternative implementation, separate address generators for storing and retrieving data provide addresses to the memory controller 655. In another alternative implementation, a separate memory controller is provided for and connected to each memory and generates addresses for the connected memory. The memory controller 655 operates to provide the mapping of pixel pages from pixels to memory locations and to control the alternation between storing and retrieving data for the memories 610 and 615. The memory controller 655 has two states: (A) connecting the first data bus 607 to the first memory 610, and the second data bus 627 to the second memory 615; and (B) connecting the first data bus 607 to the second memory 615, and the second data bus 627 to the first memory 610. Accordingly, in state A while the first memory data bus 660 is providing pixel data to be stored to the first memory 610, the second memory data bus 670 is providing pixel data retrieved from the second memory 615. Conversely, in state B while the first memory data bus 660 is providing pixel data retrieved from the first memory 610, the second memory data bus 670 is providing pixel data to be stored to the second memory 615. The memory that the memory controller 655 currently uses for storing pixel data is referred to herein as the store memory, and the memory that the memory controller 655 currently uses for retrieving pixel data is referred to herein as the retrieve memory. The memory controller 655 receives a control signal to switch between states, such as from the video source 605 on control line 630. The video source 605 toggles the control signal after completing storing pixel data for a frame. In one implementation, the memory controller 655 is connected to a flip-flop that is triggered by a vertical synchronization signal supplied by the video source 605.

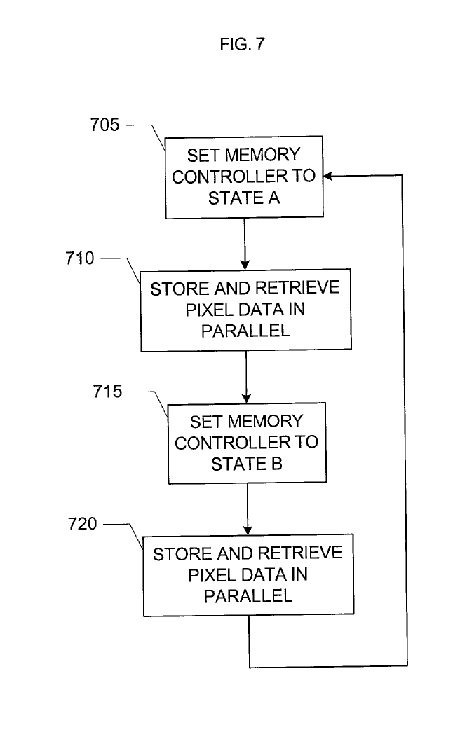

FIG. 7 is a flowchart of storing and retrieving pixel data in parallel using memory alternation, such as in the architecture 600 of FIG. 6. When a first frame of pixel data becomes available to the video source 605, the video source 605 sets the memory controller 655 to state A (pixel data to be stored to the first memory 610, pixel data to be retrieved from the second memory 615), block 705. The memory controller 655 stores the first frame of pixel data, one pixel at a time, in the first memory 610, as described below, and the memory controller 655 retrieves pixel data from the second memory 615, as described below, block 710. Initially, pixel data has not been stored in the second memory 615, and so pixel data retrieved during the first loop may not produce a desirable image. After a frame of pixel data has been stored, the video source 605 sets the memory controller 655 to state B (pixel data to be retrieved from the first memory 610, pixel data to be stored to the second memory 615), block 715. The memory controller 655 stores a frame of pixel data and retrieves pixel data for another frame according to the state of the memory controller 655, block 720. After a frame of pixel data has been stored, the video source 605 returns to block 705 and sets the memory controller 655 to state A. When a new frame is not available to video source 605, storing and retrieving pixel data is complete. When a new frame later becomes available, the video source 605 begins at block 705 again.

The pixel page geometry affects the allocation of pixel pages for each frame of pixels. The allocation of pixel pages controls the allocation of memory. As described above, an HD resolution frame has 2,073,600 pixels, in 1920 frame columns and 1080 frame rows. One implementation uses pixel pages having a pixel page geometry of 8×32, such as pixel pages 505 in FIG. 5. Each pixel page 505 is 8 pixels 510 wide, so one frame has at least 240 pixel pages 505 horizontally. Each pixel page 505 is 32 pixels 510 tall, so one frame has at least 34 pixel pages 505 vertically (though the pixel pages 505 in the 34^{th} row of pixel pages 505 are not completely filled with valid screen pixels, where a “valid” screen pixel is a pixel in the frame for which pixel data has been provided from the video source). In total, one frame has at least 8160 pixel pages 505 allocated, where each allocated pixel page has a corresponding memory page. In an HD resolution implementation, pixel data is stored and retrieved in similar sequences to those described above. Pixel data is stored along horizontal frame rows, such as this sequence of pixels: 0, 1, 2, 3, 4, and so on. Pixel data is retrieved along vertical frame columns, such as this sequence of pixels, 0, 1920, 3840, 5760, and so on. In addition, when using burst accessing, horizontally consecutive pixel pages correspond to memory pages in different banks in the memory device.

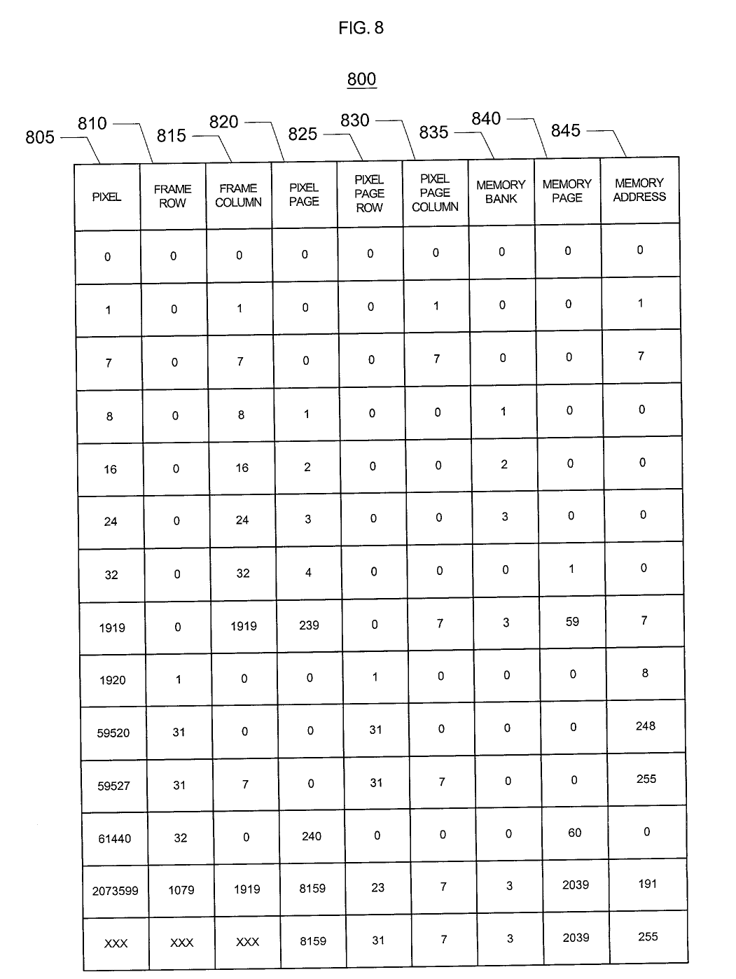

FIG. 8 is a table 800 showing the relationships among a pixel, a frame row, a frame column, a pixel page, a pixel page row, a pixel page column, a memory page, a memory address, and a memory bank for an HD resolution implementation (1920×1080) using pixel pages 505 in FIG. 5 and burst accessing. In FIG. 8, the pixel data for a frame is stored in one memory device, having 256 memory locations per memory page and four memory banks. In this implementation, pixel data for horizontally neighboring pixel pages is stored in different memory banks. In addition, FIG. 8 shows only a representative sample of pixels from a frame for clarity. As described above, an HD resolution frame has 2,073,600 pixels.

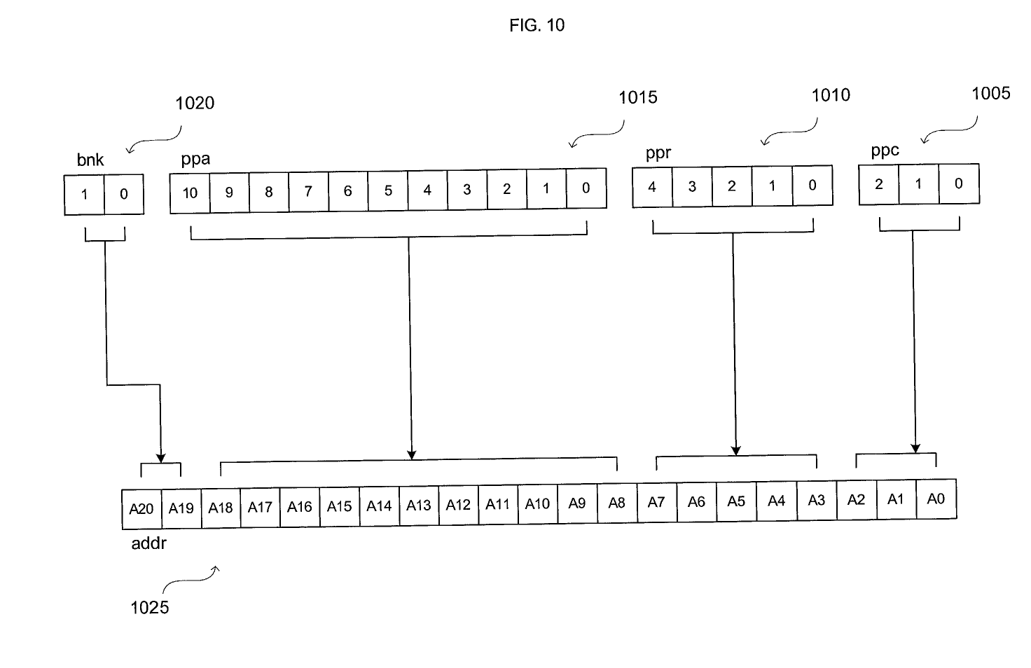

Column 805 indicates the number of a pixel for which related information is shown in table 800. Pixels in a frame are numbered from 0, left to right, top to bottom. For example, the first pixel in the frame is numbered 0, the last pixel of the first frame row is numbered 1919, and the first pixel of the second frame row is numbered 1920. Column 810 indicates a frame row including the pixel in column 805. Frame rows are numbered from 0, top to bottom. Column 815 indicates a frame column including the pixel in column 805. Frame columns are numbered from 0, left to right. Column 820 indicates a pixel page including the pixel in column 805. Pixel pages in a frame are numbered from 0, left to right, top to bottom. Column 825 indicates a pixel page row including the pixel in column 805. Pixel page rows are numbered from 0, from top to bottom within the pixel page including the pixel page row. Column 830 indicates a pixel page column including the pixel in column 805. Pixel page columns are numbered from 0, left to right within the pixel page including the pixel page column. Column 835 indicates which memory bank stores pixel data for the pixel in column 805. The four memory banks are numbered 0-3. Column 840 indicates a memory page storing pixel data for the pixel in column 805. Memory pages are numbered sequentially from 0 in each memory bank. Column 845 indicates a memory address of a memory location storing pixel data for the pixel in column 805. The memory address in column 845 indicates a location within a memory page and each memory page starts from address 0. As described below referring to FIG. 10, in one implementation, the bank number, memory page number, and memory address can be combined into one address (e.g., the bank is indicated by the uppermost address bits, then the memory page, then the location or column within the page). In an HD resolution of 1920×1080, a 21-bit address is sufficient to address the 2,073,600 4-byte locations storing pixel data for the frame. XXX indicates an invalid screen pixel, frame row, or frame column. Invalid screen pixels, frame rows, and frame columns are outside the dimensions of the screen resolution (e.g., frame rows beyond 1079 in HD resolution 1920×1080). Memory locations are allocated for invalid screen pixels, frame rows, and frame columns in allocated pixel pages, but these memory locations are not used. For example, the first pixel of a frame is pixel 0, in frame row 0 and frame column 0, in pixel page row 0 and pixel page column 0 of pixel page 0, stored in memory bank 0, in memory page 0 at memory address 0. The second pixel of a frame (horizontally) is pixel 1, in frame row 0 and frame column 1, in pixel page row 0 and pixel page column 1 of pixel page 0, stored in memory bank 0, in memory page 0 at memory address 1.

Some pixel pages at the end of each column of pixel pages do not include valid screen pixels. 34 pixel pages are allocated vertically to the frame. Each pixel page is 32 pixels tall and so 34 pixel pages can include a column of 1088 pixels vertically. However, an HD resolution frame is only 1080 pixels tall and so has valid screen pixels for 33 pixel pages and 24 pixel page rows of a 34^{th} pixel page, vertically. As a result, eight pixel page rows in each of the pixel pages in the 34^{th} row of pixel pages (i.e., pixel pages 7920 through 8159) do not include valid screen pixels. For example, pixel 2073599 (i.e., the last pixel of the last frame row) is in pixel page row 23 of pixel page 8159 and pixel data for pixel 2073599 is stored in memory bank 3, in memory page 2039, at address 191. Pixel page rows 24 through 31 of pixel page 8159 do not include valid screen pixels. However, memory page 2039 includes 256 memory locations with addresses from 0 through 255. Addresses 192 through 255 are not used in memory page 2039 in memory bank 3. A similar situation occurs in each of the memory pages in each of the memory banks corresponding to the 34^{th} row of pixel pages (i.e., memory pages 1980 through 2039 in memory banks 0 through 3).

The memory controller 655 stores pixel data according to horizontal rows of pixels. The memory controller 655 generates source addresses to store pixel data for one pixel at a time, in parallel with retrieving pixel data for a different pixel, as described below. In an HD resolution implementation, the memory controller 655 stores pixel data for pixels in this sequence: 0, 1, 2, 3, 4, 5, and so on. Referring to FIG. 8, the memory controller 655 generates addresses in the following sequence (memory bank-memory page-memory address): 0-0-0, 0-0-1, . . . , 0-0-7, 1-0-0, 1-0-1, . . . , 3-0-7, 0-1-0, 0-1-1, . . . 3-59-7, 0-0-8, 0-0-9, and so on. As described above, pixel data for pixels in different pixel pages is stored in different memory pages.

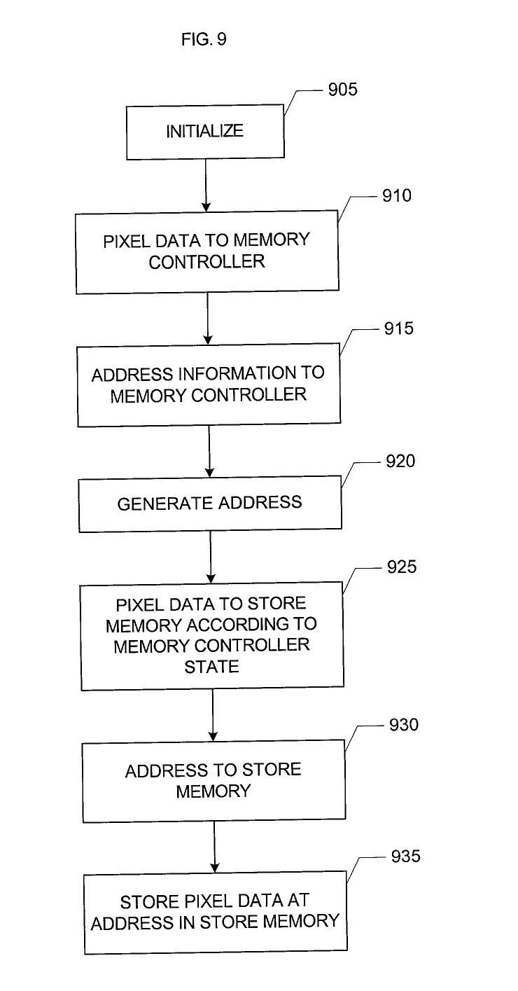

FIG. 9 is a flowchart of storing pixel data using architecture 600 in FIG. 6. To store pixel data, one of the memories 610, 615 is the store memory according to the state of the memory controller 655 for memory alternation, as described above. The memory controller 655 puts the store memory in write mode and the memory controller 655 is set to provide pixel data from the video source 605 to the store memory, block 905. The video source 605 provides pixel data for a first pixel to the memory controller 655 through the first data bus 607, block 910. The video source 605 also provides address information to the memory controller 655 through the first control line 630, block 915. The address information indicates that the memory controller 655 is to store data to one of the memories 610, 615. Alternatively, the video source 605 provides the address information to the memory controller 655 once at the beginning of storage, such as at block 905. The memory controller 655 generates a source address, as described below, to store the pixel data, block 920. In alternative implementations, the video source 605 can generate the addresses for storing pixel data and pass the addresses to the memory controller 655.

The memory controller 655 passes the data from data bus 607 to the store memory through the respective memory data bus (i.e., the first memory data bus 660 for the first memory 610 or the second memory data bus 670 for the second memory 615), block 925. The memory controller 655 provides the address to the store memory through the respective memory address bus (i.e., the first memory address bus 665 for the first memory 610 or the second memory address bus 675 for the second memory 615), block 930. The store memory stores the pixel data on the connected memory data bus at the address on the connected memory address bus, block 935. To store pixel data for the next pixel, the video source 605 returns to block 910, or to block 905 to restore the state of the architecture 600 for storage.

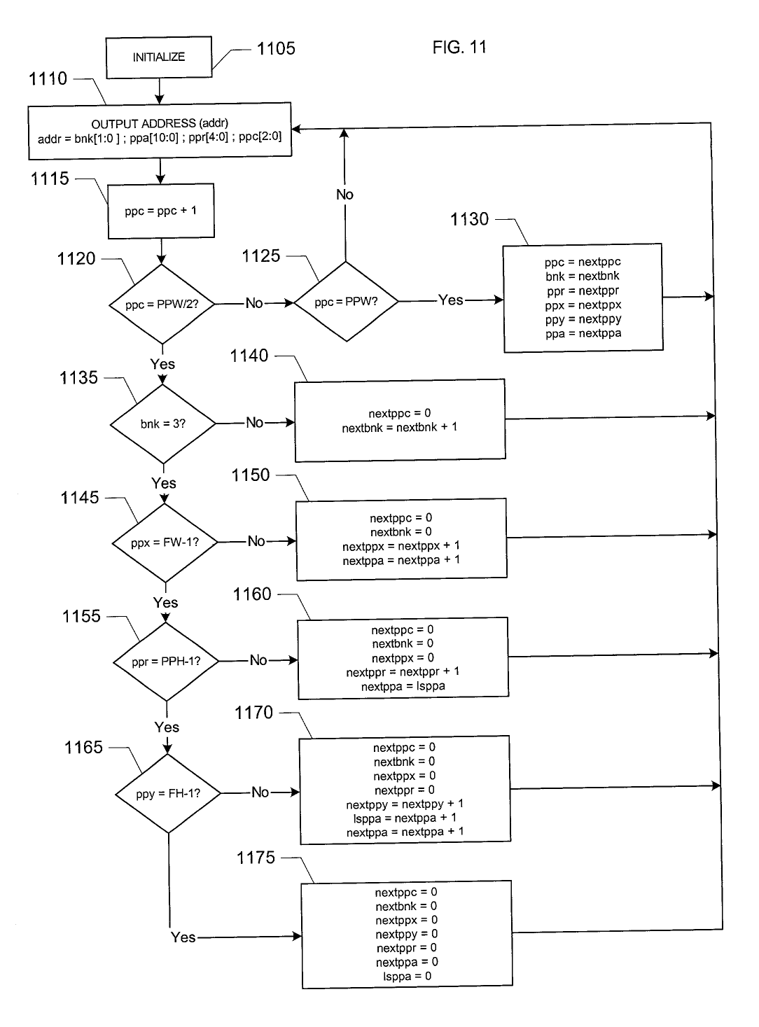

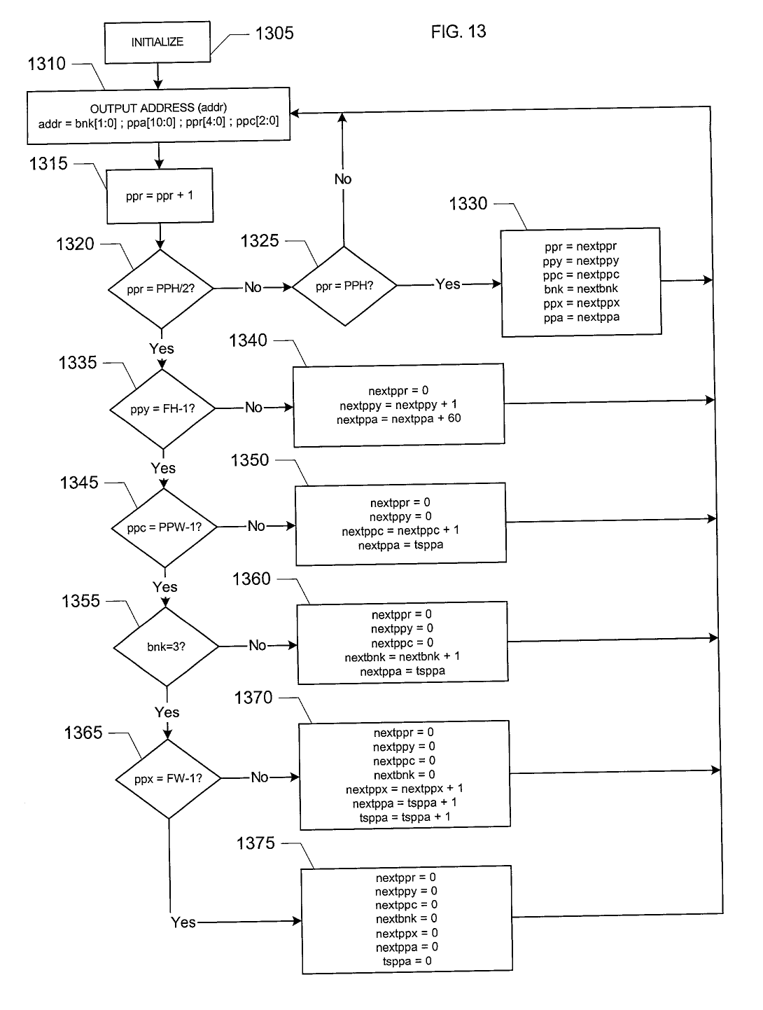

In one implementation, the memory controller 655 generates source addresses for storing pixel data and destination addresses for retrieving pixel data using several counter variables. FIG. 10 illustrates generating an address from counter variables. FIGS. 11 and 13, as described below, show flowcharts for incrementing counter variables as needed for generating source and destination addresses, respectively.

As described above, one implementation uses the architecture 600 shown in FIG. 6, a pixel page geometry of 8×32, and allocates 240 pixel pages horizontally and 34 pixel pages vertically. Several counter variables are shown in FIGS. 10, 11, and 13. These counter variables can be values stored in memory or separate counters. “addr” is the 21 bit address generated and output by the memory controller 655. As described below, addr is the 21-bit address 1025 shown in FIG. 10. In an alternative implementation, addr is mathematically derived from the variables ppc, ppr, ppa, and bnk.

“ppc” counts pixel page columns. “ppr” counts pixel page rows. Combining ppc and ppr indicates a pixel within a pixel page and also a memory location within a memory page. Values for this combination are shown in column 845 in FIG. 8. “ppx” counts pixel pages horizontally. “ppy” counts pixel pages vertically. “ppa” indicates one pixel page among the pixel pages stored in a bank of the memory being accessed. ppa also indicates the memory page in a bank storing the pixel page indicated by ppa. Values for ppa are shown in column 840 in FIG. 8. “bnk” indicates one of four banks in the memory being accessed. Values for bnk are shown in column 835 in FIG. 8. As described above, in one implementation, pixel data for horizontally neighboring pixel pages is stored in different memory banks (0, 1, 2, 3, 0, etc.) to take advantage of burst accessing while storing pixel data. bnk tracks which bank to store data to or retrieve data from according to this sequence.

As shown FIG. 10, the combination of ppc, ppr, ppa, and bnk form a 21-bit address. For a pixel page geometry of 8×32, ppc ranges from 0 to 7 and can be represented by three bits 1005. ppr ranges from 0 to 31 and can be represented by five bits 1010. ppa ranges from 0 to 2039 (60 pixel pages horizontally per bank by 34 pixel pages vertically) and can be represented by 11 bits 1015. bnk ranges from 0 to 3 and can be represented by two bits 1020. The memory controller 655 combines these bits 1005, 1010, 1015, 1020 to form a 21-bit address 1025, addr. Bits of address 1025 are numbered from A0 to A20. As shown in FIG. 10, ppc bits 1005 become address bits A0-A2. ppr bits 1010 become address bits A3-A7. ppa bits 1015 become address bits A8-A18. bnk bits 1020 become address bits A19-A20.

“nextppc,” “nextppr,” “nextppx,” “nextppy,” “nextppa,” and “nextbnk” are holding variables for assignment. In FIG. 11, “lsppa” indicates a pixel page at the left side of the frame, and is used for the address to start from when generating addresses at the beginning of a row of pixels. In FIG. 13, “tsppa” indicates a pixel page at the top side of the frame, and is used for the address to start from when generating addresses at the beginning of a column of pixels.

Several constants are also shown in FIGS. 11 and 13. “FW” is the frame width, indicating the number of pixel pages allocated horizontally stored within one bank of the memory being accessed. As described above, using 8×32 pixel pages, 240 pixel pages are allocated horizontally. 60 pixel pages are stored for each row of pixel pages in each bank. Accordingly, FW is 60 in this implementation. “FH” is the frame height, indicating the number of pixel pages allocated vertically. FH is 34 in this implementation. “PPW” is the pixel page width, indicating the width of a pixel page in pixels. Using a pixel page geometry of 8×32, PPW is 8. “PPH” is the pixel page height, indicating the height of a pixel page in pixels. Using a pixel page geometry of 8×32, PPH is 32.

FIG. 11 is a flowchart of generating source addresses for storing pixel data. At the beginning of storing pixel data for a frame, the memory controller 655 resets the variables ppc, ppr, ppx, ppy, ppa, bnk, nextppc, nextppr, nextppx, nextppy, nextppa, nextbnk, and lsppa to 0, block 1105. FW, FH, PPW, and PPH do not change from frame to frame. The memory controller 655 generates addr as shown in FIG. 10 and outputs the value of addr as the address, block 1110. The memory controller 655 increments ppc by 1, block 1115. The memory controller 655 compares ppc with PPW/2, block 1120. PPW/2 indicates the horizontal middle of the pixel page. Where PPW is 8, PPW/2 is 4. In some implementations, the amount of time required to perform some of the calculations in FIG. 11 may be more than a pixel time, and so using PPW/2 as a branching point allows more time for some calculations to complete. Accordingly, processing may move from one block to another in FIG. 11 before the calculation shown in a block has completed. Alternatively, a value other than the horizontal middle of the pixel page can be used.

If ppc does not equal PPW/2, the memory controller 655 checks if the end of a pixel page has been reached by comparing ppc with PPW, block 1125. If ppc does not equal PPW, the end of the pixel page has not been reached, and the memory controller 655 proceeds to block 1110. If ppc equals PPW, the end of the pixel page has been reached. The memory controller 655 prepares for the next pixel page by assigning counter variables the values of corresponding holding variables, block 1130, and proceeds to block 1110.

Returning to block 1120, if ppc equals PPW/2, the memory controller 655 checks if the last bank in the sequence of banks has been reached by comparing bnk with 3, block 1135. As described above, pixel pages are stored in a sequence of banks (0, 1, 2, 3, 0, etc.) to take advantage of burst accessing while storing pixel data. If bnk does not equal 3, the last bank has not been reached. The memory controller 655 prepares holding variables for the end of the pixel page row (to be used in block 1130), block 1140, and proceeds to block 1110. In an implementation where each memory has more or less than 4 banks, the memory controller 655 compares bnk with one less than the number of banks in each memory.

If bnk equals 3, the last bank has been reached, and the memory controller 655 checks if the last pixel page in the row of pixel pages has been reached by comparing ppx with FW-1, block 1145. Where FW is 60, FW-1 is 59. When bnk equals 3 and ppx equals FW-1, the last pixel page in the row of pixel pages has been reached. If ppx does not equal FW-1, the last pixel page in the row has not been reached. The memory controller 655 prepares holding variables for the end of the pixel page row (to be used in block 1130), block 1150, and proceeds to block 1110.

If ppx equals FW-1, the last pixel page in the row has been reached, and the memory controller 655 checks if the last pixel page row in the pixel page has been reached by comparing ppr with PPH-1, block 1155. Where PPH is 32, PPH-1 is 31. If ppr does not equal PPH-1, the last pixel page row has not been reached. The memory controller 655 prepares holding variables for the end of the pixel page row (to be used in block 1130), block 1160, and proceeds to block 1110.

If ppr equals PPH-1, the last pixel page row has been reached, and the memory controller 655 checks if the last pixel page in the column of pixel pages has been reached by comparing ppy with FH-1, block 1165. Where FH is 34, FH-1 is 33. If ppy does not equal FH-1, the last pixel page in the column has not been reached. The memory controller 655 prepares holding variables for the end of the pixel page row (to be used in block 1130), block 1170, and proceeds to block 1110. If ppy equals FH-1, the last pixel page in the column has been reached. The memory controller 655 prepares holding variables for the end of the pixel page row (to be used in block 1130), block 1175, and proceeds to block 1110. FIG. 11 shows a continuous loop and so the memory controller 655 continues to follow FIG. 11 from frame to frame for storing pixel data. If the memory controller 655 needs to re-start address generation for storing pixel data, such as to re-initialize the state of address generation, the memory controller 655 starts generating addresses again beginning with block 1105.

The memory controller 655 retrieves pixel data according to vertical columns of pixels. The memory controller 655 generates destination addresses to retrieve pixel data for one pixel at a time, in parallel with storing pixel data for a different pixel, as described above. In an HD resolution implementation, the memory controller 655 retrieves pixel data for pixels in this sequence: 0, 1920, 3840, and so on. Referring to FIG. 8, the memory controller 655 generates addresses in the following sequence (memory bank-memory page-memory address): 0-0-0, 0-0-8, 0-0-16, . . . , 0-0-240, 0-60-0, 0-60-8, . . . , 0-1980-240, 1-0-0, 1-0-8, and so on. As described above, pixel data for pixels in different pixel pages is retrieved from different memory pages.

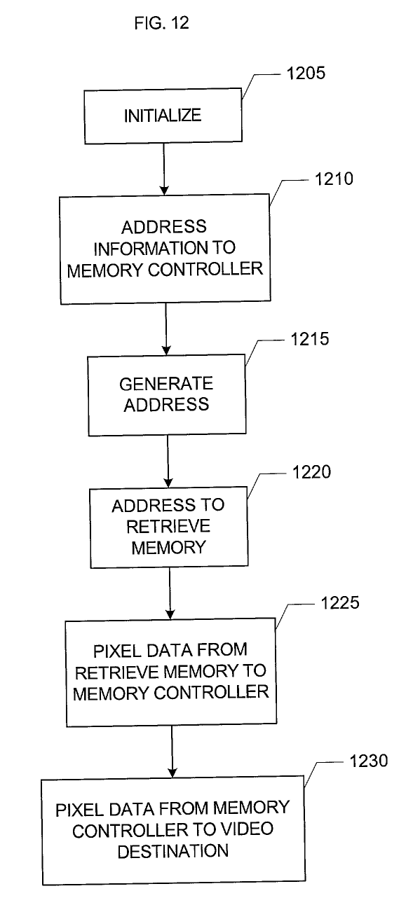

FIG. 12 is a flowchart of retrieving pixel data. To retrieve pixel data, one of the memories 610, 615 is the retrieve memory according to the state of the memory controller 655 for memory alternation, as described above. The memory controller 655 puts the retrieve memory in read mode and the memory controller 655 is set to provide pixel data from the retrieve memory to the video destination 625, block 1205. The video destination 625 provides address information to the memory controller 655 through the second control line 635, block 1210. The address information indicates that the memory controller 655 is to read data from one of the memories 610, 615. Alternatively, the video destination 625 provides the address information to the memory controller 655 once at the beginning of retrieval, such as at block 1205. The memory controller 655 generates a destination address as described below to retrieve the pixel data, block 1215. In alternative implementations, the video destination 625 can generate the addresses for retrieving pixel data and pass the addresses to the memory controller 655.

The memory controller 655 provides the destination address to the retrieve memory through the respective memory address bus (i.e., the first memory address bus 665 for the first memory 610 or the second memory address bus 675 for the second memory 615), block 1220. The retrieve memory provides the pixel data stored at the address on the connected memory address bus to the memory controller 655 through the connected memory data bus (i.e., the first memory data bus 660 for the first memory 610 or the second memory data bus 670 for the second memory 615), block 1225. The memory controller 655 provides the pixel data from the retrieve memory to the video destination 625 through the second data bus 627, block 1230. To retrieve pixel data for the next pixel, the video destination returns to block 1210, or to block 1205 to restore the state of the architecture 600 for retrieval.

FIG. 13 is a flowchart of generating destination addresses for retrieving pixel data. At the beginning of retrieving pixel data for a frame, the memory controller 655 resets the variables ppc, ppr, ppx, ppy, ppa, bnk, nextppc, nextppr, nextppx, nextppy, nextppa, nextbnk, and tsppa to 0, block 1305. FW, FH, PPW, and PPH do not change from frame to frame. The memory controller 655 generates addr as shown in FIG. 10 and outputs the value of addr as the address, block 1310. The memory controller 655 increments ppr by 1, block 1315. The memory controller 655 compares ppr with PPH/2, block 1320. PPH/2 indicates the vertical middle of the pixel page. Where PPH is 32, PPH/2 is 16. As described above referring to FIG. 11, using PPH/2 as a branching point allows more time for some calculations to complete.

If ppr does not equal PPH/2, the memory controller 655 checks if the end of a pixel page has been reached by comparing ppr with PPH, block 1325. If ppr does not equal PPH, the end of the pixel page has not been reached, and the memory controller 655 proceeds to block 1310. If ppr equals PPH, the end of the pixel page has been reached. The memory controller 655 prepares for the next pixel page by assigning counter variables the values of corresponding holding variables, block 1330, and proceeds to block 1310.

Returning to block 1320, if ppr equals PPH/2, the memory controller 655 checks if the last pixel page in the column of pixel pages has been reached by comparing ppy with FH-1, block 1335. Where FH is 34, FH-1 is 33. If ppy does not equal FH-1, the last pixel page in the column has not been reached. The memory controller 655 prepares holding variables for the end of the pixel page column (to be used in block 1330), block 1340, and proceeds to block 1310.

If ppy equals FH-1, the last pixel page in the column has been reached, and the memory controller 655 checks if the last pixel page column in the pixel page has been reached by comparing ppc with PPW-1, block 1345. Where PPW is 8, PPW-1 is 7. If ppc does not equal PPW-1, the last pixel page column has not been reached. The memory controller 655 prepares holding variables for the end of the pixel page column (to be used in block 1330), block 1350, and proceeds to block 1310.

If ppc equals PPW-1, the last pixel page column has been reached, and the memory controller 655 checks if the last bank in the sequence of banks has been reached by comparing bnk with 3, block 1355. As described above, pixel pages are stored in a sequence of banks (0, 1, 2, 3, 0, etc.) to take advantage of burst accessing while storing pixel data. If bnk does not equal 3, the last bank has not been reached. The memory controller 655 prepares holding variables for the end of the pixel page row (to be used in block 1330), block 1360, and proceeds to block 1310. In an implementation where each memory has more or less than 4 banks, the memory controller 655 compares bnk with one less than the number of banks in each memory.

If bnk equals 3, the last bank has been reached, and the memory controller 655 checks if the last pixel page in the row of pixel pages has been reached by comparing ppx with FW-1, block 1365. Where FW is 60, FW-1 is 59. When bnk equals 3 and ppx equals FW-1, the last pixel page in the row of pixel pages has been reached. If ppx does not equal FW-1, the last pixel page in the row has not been reached. The memory controller 655 prepares holding variables for the end of the pixel page column (to be used in block 1330), block 1370, and proceeds to block 1310. If ppx equals FW-1, the last pixel page in the row has been reached. The memory controller 655 prepares holding variables for the end of the pixel page column (to be used in block 1330), block 1375, and proceeds to block 1310. Similar to FIG. 11, FIG. 13 shows a continuous loop and so the memory controller 655 continues to follow FIG. 13 from frame to frame for retrieving pixel data. If the memory controller 655 needs to re-start address generation for retrieving pixel data, such as to re-initialize the state of address generation, the memory controller 655 starts generating addresses again beginning with block 1305.

In alternative implementations, addresses generation for storing and retrieving pixel data can be different from that described above. For example, blocks 1120 and 1125 in FIG. 11 could be combined into a multi-branch block with outgoing paths depending on the value of ppc: one for ppc=PPW/2, one for ppc=PPW, and one for other values of ppc. In any case, the address generation used accommodates the storage pattern created by the pixel pages and the sequences for storing and retrieving data described above.

Referring again to the vertical scaling system 300 shown in FIG. 3 and the flowchart of the operation of the vertical scaling system shown in FIG. 4, in block 410, the pixel page system 305 uses pixel pages to store pixel data according to horizontal rows of pixels and retrieve the pixel data according to vertical columns of pixels. The pixel page system 305 stores pixel data for one pixel in one memory and retrieves pixel data for one pixel from another memory in parallel (alternating memories with each frame), as described above referring to FIGS. 6 through 12.

The pixel page system 305 provides the pixel data according to vertical columns of pixels to the scaling engine 310. The scaling engine 310 scales the pixel data to correct the vertical distortion. Any of various known techniques of scaling for vertical distortion correction can be used according to the type of distortion to be corrected. Some of these techniques may be variations of known techniques for horizontal distortion correction. Such variations will be apparent to one of ordinary skill in the art. The vertical scaling system 300 advantageously uses the pixel page system 305 to provide the pixel data to the vertical scaling engine according to vertical columns of pixels. Accordingly, the scaling engine 310 scales pixel data without internally buffering an entire frame to have access to pixel data for each column of pixels. In addition, because the pixel page system 305 stores and retrieves pixel data in parallel, the scaling engine 310 does not wait for each frame to be buffered, but instead receives a stream of pixel data from the pixel page system 305. As a result, the vertical scaling system 300 can provide real-time distortion correction. To further improve speed, different types of pixel page systems with increased parallelism can be used, such as the checkerboard pixel page systems described in the following patent applications: U.S. application Ser. No. 10/076,685, entitled CHECKERBOARD BUFFER USING TWO-DIMENSIONAL BUFFER PAGES, filed Feb. 14, 2002 (Docket No. 72705), U.S. application Ser. No. 10/076,942, entitled CHECKERBOARD BUFFER USING TWO-DIMENSIONAL BUFFER PAGES AND USING STATE ADDRESSING, filed Feb. 14, 2002 (Docket No. 72706); U.S. application Ser. No. 10/076,832, entitled CHECKERBOARD BUFFER USING TWO-DIMENSIONAL BUFFER PAGES AND USING BIT-FIELD ADDRESSING, filed Feb. 14, 2002 (Docket No. 72707); and U.S. application No. Ser. No. 10/076,943, entitled CHECKERBOARD BUFFER USING TWO-DIMENSIONAL BUFFER PAGES AND USING MEMORY BANK ALTERNATION, filed Feb. 14, 2002 (Docket No. 72708), the disclosures of which are incorporated herein by reference.

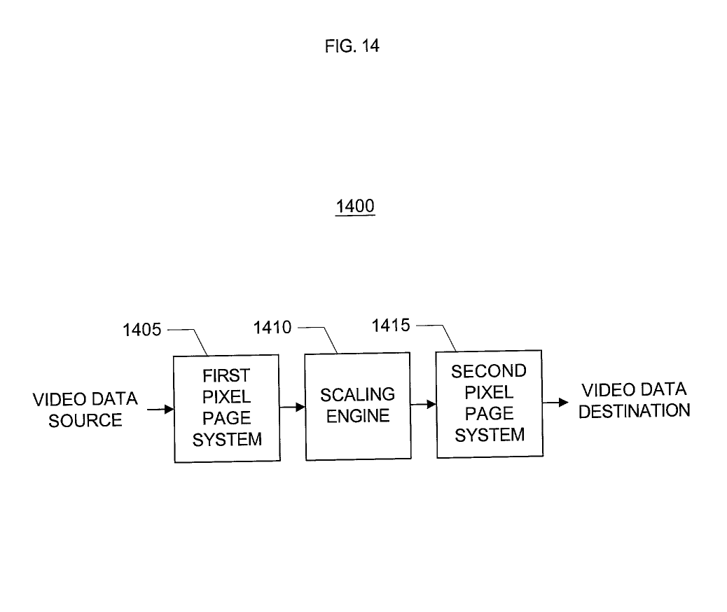

FIG. 14 shows another implementation of a vertical scaling system 1400. The vertical scaling system 1400 receives pixel data from an external video data source, such as a broadcast source or a software application running on a computer system, and provides scaled pixel data to an external video destination, such as an external projection system. The vertical scaling system 1400 includes a first pixel page system 1405, a scaling engine 1410, and a second pixel page system 1415, connected in series. The first pixel page system 1405 and the scaling engine 1410 are implemented as described above referring to FIGS. 3 through 13. The second pixel page system 1415 is similar to the first pixel page system 1405 but stores pixel data according to vertical columns and retrieves pixel data according to horizontal rows.

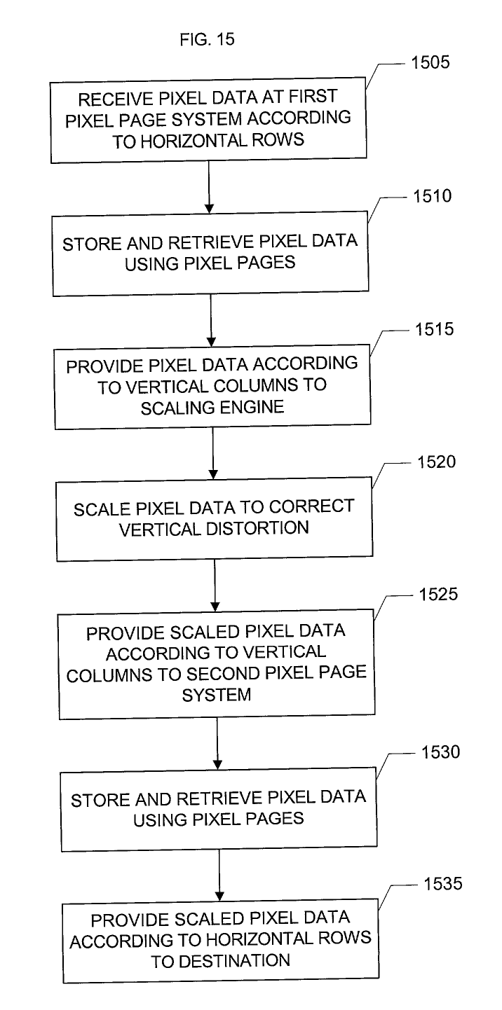

FIG. 15 is a flowchart of the operation of the vertical scaling system 1400 shown in FIG. 14. The first pixel page system 1405 receives pixel data according to horizontal rows of pixels in a frame from an external video data source, block 1505. The first pixel page system 1405 uses pixel pages to store pixel data according to horizontal rows of pixels and retrieve the pixel data according to vertical columns of pixels, block 1510. The first pixel page system 1405 provides the pixel data according to vertical columns of pixels to the scaling engine 1410, block 1515. The scaling engine 1410 scales the pixel data for each column, block 1520. The scaling engine 1410 scales pixel data according to vertical columns of pixels, such as to correct vertical keystone distortion. The scaling engine 1410 provides the scaled pixel data, according to vertical column of pixels, to the second pixel page system 1415, block 1525. The second pixel page system 1415 uses pixel pages to store the scaled pixel data from the scaling engine 1410 according to vertical columns of pixels and retrieve the scaled pixel data according to horizontal rows of pixels, block 1530. The second pixel page system 1415 provides the scaled pixel data, according to horizontal rows of pixels, to an external video destination, block 1535.

In one implementation, the vertical scaling system 1400 including two pixel page systems provides the scaled pixel data to a GLV pixel compensation system. GLV systems are described in more detail in the related applications referenced above (e.g., U.S. application Ser. No. 10/051,538, filed Jan. 16, 2002 (Docket No. 71743)). In overview, a GLV system projects an image using a horizontal scan by projecting a column of pixels at a time. The GLV system includes a ribbon of GLV pixels.

Variations among the GLV pixels in a ribbon can cause variations in brightness in the resulting projected column of pixels. A GLV compensation system adjusts the pixel data provided to the GLV pixels to compensate for these variations, such as by using a table based on previously established GLV pixel properties. Because a row of pixels in the projected image corresponds to a single GLV pixel, it is desirable to process the pixel data for GLV pixel compensation according to horizontal rows of pixels so that a single table access can be made for each row. Accordingly, the vertical scaling system 1400 advantageously provides the scaled pixel data according to horizontal rows of pixels to the GLV pixel compensation system. The GLV pixel compensation system provides the adjusted pixel data to a third pixel page system. The third pixel page system stores the adjusted pixel data according to horizontal rows and retrieves the adjusted pixel data according to vertical columns. The third pixel page system provides the adjusted pixel data to a GLV system according to vertical columns of pixels for display.

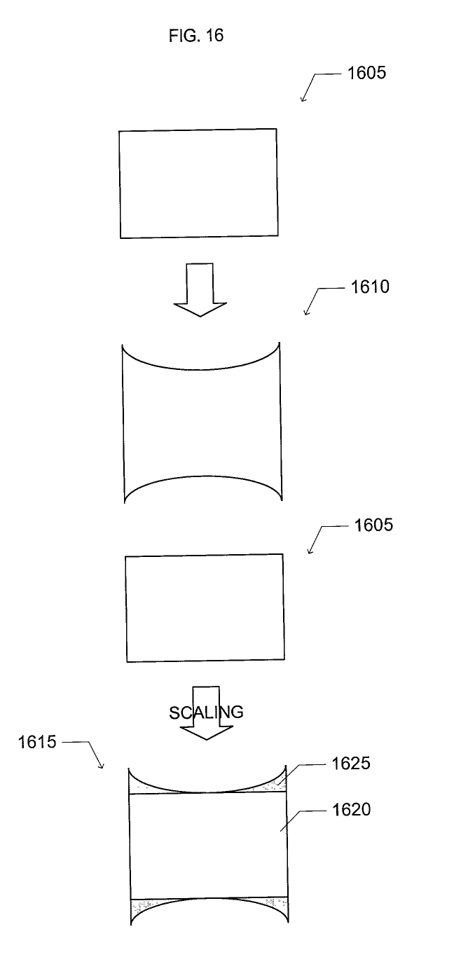

While the description above focuses on correcting vertical keystone distortion, the vertical scaling systems can be used for correcting various vertical distortions. FIG. 16 illustrates an example of vertical bowtie image distortion, such as that characteristic of a GLV projection display. Similar to the vertical keystone distortion shown in FIG. 2, a rectangular frame of pixels 1605 has a bowtie projected image 1610 (exaggerated from typical distortion for FIG. 16). In the example shown in FIG. 16, the center column of pixels appears undistorted while each column of pixels to the right or left of that center column appears progressively more stretched and so the same number of pixels occupy a taller space in the outer columns.

Similar to correcting vertical keystone distortion, applying vertical bowtie correction to the pixel data before the image is projected can hide the vertical keystone distortion. Vertical bowtie correction scales the pixel data for a column of pixels. A scaling engine scales the pixel data for each column and provides the scaled data to a projection system. The projection system projects an image according to vertical columns of pixels using the scaled pixel data forming a scaled projection 1615. Each column of pixel data is scaled to form a visible section 1620 of pixels that is of approximately constant height from column to column. Pixels at the edge of the visible section 1620 are aliased to enhance the appearance of a smooth edge for the visible section 1620. Due to the bowtie distortion, some columns have fewer pixels in the visible section 1620 than others. The remaining pixels form blacked-out sections 1625 on either side of the visible portion 1620. Pixels in the blacked-out section 1625 either have black data (e.g., projected as black) or the pixels are not lit at all.

The vertical scaling system 300 shown in FIG. 3 can be used to correct vertical bowtie distortion. Similar to vertical keystone correction, any of various known vertical scaling techniques can be used to correct vertical bowtie distortion in the scaling engine. Accordingly, the operation of the vertical scaling system 300 when correcting vertical bowtie distortion is similar to that when correcting vertical keystone distortion, however the scaling used in the scaling engine 3 1 0 will be different. Similarly, a vertical scaling system as described above can be implemented to correct other vertical image distortions as well by using appropriate scaling within the scaling engine.

The vertical scaling systems described above can be combined with techniques for correcting horizontal distortion as well. The resulting combinations could be used to correct two-dimensional image distortion.

Various illustrative implementations of the present invention have been described. However, one of ordinary skill in the art will see that additional implementations are also possible and within the scope of the present invention. For example, while the above description focuses on implementations based on pixel data for a high definition resolution of 1920×1080, vertical scaling systems for other resolutions are also useful in carrying out the invention. Similarly, while the vertical scaling systems have been described in terms of correcting vertical image distortion, these systems can also be applied to other situations where image data is to be adjusted or warped using vertical scaling.

The present invention can be implemented in electronic circuitry, computer hardware, software, or in combinations of them. For example, the pixel page systems and scaling engine can be implemented in various ways, such as with an FPGA, a hardwired design, a microprocessor architecture, or a combination. However, one of ordinary skill in the art will see that additional implementations are also possible and within the scope of the present invention. Accordingly, the present invention is not limited to only those implementations described above.

What is claimed is:

1. A vertical scaling system, comprising
a pixel page system, where the pixel page system stores pixel data using pixel pages according to horizontal rows of pixels in a frame and retrieves pixel data using pixel pages according to vertical columns of pixels in a frame; and
a scaling engine connected to the pixel page system, where the scaling engine scales pixel data according to vertical columns of pixels in a frame.

2. The vertical scaling system of claim 1, where the scaling engine scales pixel data to correct vertical image distortion.

3. The vertical scaling system of claim 2, where the vertical image distortion is vertical keystone distortion.

4. The vertical scaling system of claim 2, where the vertical image distortion is vertical bowtie distortion.

5. The vertical scaling system of claim 1, where the scaling engine scales pixel data in real-time.

6. The vertical scaling system of claim 1, where the scaling engine changes the pixel data to form a resulting scaled image including a visible section and one or more blacked-out sections.

7. The vertical scaling system of claim 1, where the scaling engine scales pixel data for a target pixel without receiving pixel data for any other pixels in the same horizontal row as the pixel.

8. The vertical scaling system of claim 1, where the scaling engine scales pixel data for a target column of pixels without receiving pixel data for any pixels in a different vertical column than the target column of pixels.

9. The vertical scaling system of claim 1, where each pixel page has a pixel page geometry of 8×32.

10. The vertical scaling system of claim 1, where the pixel page system includes a memory controller, a first memory, and a second memory, where the memory controller controls storing and retrieving pixel data using pixel pages.

11. The vertical scaling system of claim 10, where the memory controller has two states: storing pixel data to the first memory while retrieving pixel data from the second memory, and retrieving pixel data from the first memory while storing pixel data to the second memory.

12. The vertical scaling system of claim 11, where the memory controller switches states at the end of storing a frame of pixels.

13. The vertical scaling system of claim 10, where each of the memories includes two or more memory banks and where pixel data for horizontally neighboring pixel pages is stored in different memory banks.

14. The vertical scaling system of claim 1, further comprising a second pixel page system connected to the scaling engine, where the second pixel page system receives scaled pixel data from the scaling engine and stores the scaled pixel data using pixel pages according to vertical columns of pixels in a frame and retrieves the scaled pixel data using pixel pages according to horizontal rows of pixels in a frame.

15. A method of scaling pixel data, comprising:
receiving pixel data for a frame of pixels according to horizontal rows of pixels in the frame;
storing the pixel data according to horizontal rows of pixels in the frame using pixel pages;
retrieving the pixel data according to vertical columns of pixels in the frame using pixel pages; and
scaling the pixel data according to vertical columns of pixels in the frame.

16. The method of claim 15, where the scaling of pixel data is to correct vertical image distortion.

17. The method of claim 16, where the vertical image distortion is vertical keystone distortion.

18. The method of claim 16, where the vertical image distortion is vertical bowtie distortion.

19. The method of claim 15, where the scaling of pixel data occurs in real-time.

20. The method of claim 15, where pixel data for a pixel from a first frame is retrieved while pixel data for a pixel from a second frame is stored.

21. The method of claim 15, further comprising:
storing the scaled pixel data according to vertical columns of pixels in the frame using pixel pages; and
retrieving the scaled pixel data according to horizontal rows of pixels in the frame using pixel pages.

22. A system for scaling pixel data, comprising:
means for receiving pixel data for a frame of pixels according to horizontal rows of pixels in the frame;
means for storing the pixel data according to horizontal rows of pixels in the frame using pixel pages;
means for retrieving the pixel data according to vertical columns of pixels in the frame using pixel pages; and
means for scaling the pixel data according to vertical columns of pixels in the frame.

23. The system of claim 22, where the scaling of pixel data is to correct vertical image distortion.

24. The system of claim 22, further comprising:
means for storing the scaled pixel data according to vertical columns of pixels in the frame using pixel pages; and
means for retrieving the scaled pixel data according to horizontal rows of pixels in the frame using pixel pages.
